(19) United States
(12) Patent Application Publication
(10) Pub. No.: US 2015/0005920 A1
(43) Pub. Date: Jan. 1, 2015

(54) 3D Printing Device, 3D Printing System and 3D Printing Method

(71) Applicant: pita4 mobile LLC, Palo Alto, CA (US)

(72) Inventor: Kazuhiko Matsumoto, Palo Alto, CA (US)

(73) Assignee: pita4 mobile LLC, Palo Alto, CA (US)

(21) Appl. No.: 13/929,507

(22) Filed: Jun. 27, 2013

(51) Int. Cl. G05B 19/042

(52) U.S. Cl. CPC G05B 19/042
USPC 700/119

(57) ABSTRACT

The three-dimensional printing apparatus includes a main unit and movement means that is connected to the main unit, in which the main unit has a printing unit for printing by laminating a target printing object and a stage portion at a printing locus, the movement means moves the three-dimensional printing apparatus over the printing locus with a stage portion that is printed by the printing unit as a stage, and the printing unit prints at least a part of a target printing object at a position to which the three-dimensional printing apparatus is moved.

### BACKGROUND OF THE INVENTION

1. Field of the Invention

The present invention relates to a three-dimensional printing apparatus, a three-dimensional printing system and a three-dimensional printing method, and in particular, relates to a three-dimensional printing apparatus that is capable of moving over a printing locus, a three-dimensional printing system having a plurality of the three-dimensional printing apparatus, and a three-dimensional printing method that produces a target printing object using the three-dimensional printing apparatus.

2. Background Art

A technique that uses a three-dimensional printing apparatus is an example of a technique that produces a three-dimensional target printing object. Such three-dimensional printing apparatuses are normally referred to as 3D printers and can print the three-dimensional target printing object by laminating a plurality of two-dimensional layers.

An apparatus that produces a three-dimensional pattern using an ink jet method has been disclosed as such a three-dimensional printer in Japanese Unexamined Patent Application Publication No. 2008-302701.

However, in the type of apparatus of the related art such as that disclosed in Japanese Unexamined Patent Application Publication No. 2008-302701, it is not possible to produce a target printing object that is larger than the size of the apparatus, and there is a problem in that there is a restriction on the size of the target printing object to be formed.

### SUMMARY OF THE INVENTION

An object of the present invention is to solve the abovementioned problem and provide a three-dimensional printing apparatus, a three-dimensional printing system and a three-dimensional printing method in which there is no restriction on the size of a target printing object to be formed.

According to an aspect of the present invention, a three-dimensional printing apparatus includes a main unit and movement means that is connected to the main unit, the main unit has a printing unit for printing by laminating a target printing object and a stage portion at a printing locus, the movement means moves the three-dimensional printing apparatus over the printing locus with a stage portion that is printed by the printing unit as a stage, and the printing unit prints at least a part of a target printing object at a position to which the three-dimensional printing apparatus is moved.

In the three-dimensional printing apparatus according to the aspect of the present invention, the stage portion may be a rail, and the movement means may have a support leg portion that is capable of traveling on the rail.

In the three-dimensional printing apparatus according to the aspect of the present invention, the support leg portion may be a wheel that rotates on the rail or a sliding body that slides on the rail.

In the three-dimensional printing apparatus according to the aspect of the present invention, the printing unit may expand the rail in a direction that is parallel to a lamination surface and an extension direction of the rail.

In the three-dimensional printing apparatus according to the aspect of the present invention, the printing unit may expand the rail in a direction that is perpendicular to the lamination surface.

In the three-dimensional printing apparatus according to the aspect of the present invention, the rail may be a pair of rails, and printing may be performed so that a gap between the rails continuously changes.

In the three-dimensional printing apparatus according to the aspect of the present invention, the movement means may have a pinion portion that is a gear, and the rail may be a rack rail that meshes with the pinion portion.

In the three-dimensional printing apparatus according to the aspect of the present invention, the stage portion may be a plurality of support pillars that are disposed like islands, and the movement means may have a support leg portion that is capable of moving on the support pillars.

In the three-dimensional printing apparatus according to the aspect of the present invention, the printing unit may increase the support pillars in a direction that is parallel to a lamination surface.

In the three-dimensional printing apparatus according to the aspect of the present invention, the printing unit may expand the support pillars in a direction that is perpendicular to the lamination surface.

In the three-dimensional printing apparatus according to the aspect of the present invention, the main unit may have a printing area expansion unit for expanding an area in which printing using the printing unit is possible.

In the three-dimensional printing apparatus according to the aspect of the present invention, the printing unit may be provided so as to be moveable with a rod portion as an axis that is provided inside the main unit, and the printing area expansion unit may expand the rod portion.

In the three-dimensional printing apparatus according to the aspect of the present invention, the printing unit may be connected to the main unit by an arm that has one or more joint portions, and it may be possible to change an angle of the lamination surface of the printing unit.

In the three-dimensional printing apparatus according to the aspect of the present invention, the main unit may have a machining unit for carrying out a machining process on a target printing object or a stage portion printed by the printing unit.

In the three-dimensional printing apparatus according to the aspect of the present invention, the three-dimensional printing apparatus may be provided with a position recognition unit for recognizing the position of the three-dimensional printing apparatus on the printing locus.

In the three-dimensional printing apparatus according to the aspect of the present invention, the position recognition unit may have an image capture unit that captures an image of at least one of a part of the three-dimensional printing apparatus, the printing locus, a target printing object or a stage portion and recognizes the position of the three-dimensional printing apparatus on the basis of an image captured by the image capture unit.

In the three-dimensional printing apparatus according to the aspect of the present invention, the printing unit may print a reference portion that forms a reference for the position recognition unit to recognize the position of the three-dimensional printing apparatus.

In the three-dimensional printing apparatus according to the aspect of the present invention, the position recognition unit may have an image capture unit that captures an image of at least one of a part of the three-dimensional printing apparatus, the printing locus, a target printing object, a stage portion or a reference portion, and recognizes the position of the three-dimensional printing apparatus on the basis of an image captured by the image capture unit.

According to another aspect of the present invention, a three-dimensional printing system includes a first three-dimensional printing apparatus which is provided with a main unit and movement means that is connected to the main unit, in which the main unit has a printing unit for printing by laminating a target printing object and a stage portion at a printing locus, the movement means moves the three-dimensional printing apparatus over the printing locus with a stage portion that is printed by the printing unit as a stage, and the printing unit prints at least a part of a target printing object at a position to which the three-dimensional printing apparatus is moved; and a second three-dimensional printing apparatus that is provided with a main unit and movement means that is connected to the main unit, in which the main unit has a printing unit for printing by laminating a target printing object and a stage portion at a printing locus, the movement means moves the three-dimensional printing apparatus over the printing locus with a stage portion that is printed by the printing unit as a stage, and the printing unit prints at least a part of a target printing object at a position to which the three-dimensional printing apparatus is moved, and the first three-dimensional printing apparatus and the second three-dimensional printing apparatus cooperate in the printing of the same target printing object.

According to still another aspect of the present invention, a method for performing three-dimensional printing using a three-dimensional printing apparatus that is provided with a main unit and movement means that is connected to the main unit includes a stage portion printing step of printing by laminating a stage portion, a movement step of moving the three-dimensional printing apparatus over a printing locus with a stage portion that is printed in the stage portion printing step as a stage, and a target printing object printing step of printing by laminating at least a part of a target printing object at a position to which the three-dimensional printing apparatus is moved.

According to the three-dimensional printing apparatus and three-dimensional printing system of the present invention, it is possible to increase a printable area of a three-dimensional printing apparatus due to the movement means moving the three-dimensional printing apparatus with a stage portion that is printed by the printing unit as a stage.

According to the three-dimensional printing method of the present invention, it is possible to increase a printable area of a three-dimensional printing apparatus by moving the three-dimensional printing apparatus with a stage portion that is printed in the stage portion printing step as a stage.

### BRIEF DESCRIPTION OF THE DRAWINGS

FIG. 1A is a plan view that schematically shows a three-dimensional printing apparatus that complies with a first embodiment of the present invention.

FIG. 1B is a front view that schematically shows a three-dimensional printing apparatus that complies with the first embodiment of the present invention.

FIG. 1C is a side view that schematically shows a three-dimensional printing apparatus that complies with the first embodiment of the present invention.

FIG. 2 is a plan view that schematically shows a three-dimensional printing apparatus that complies with the first embodiment of the present invention.

FIG. 3 is a plan view that schematically shows a three-dimensional printing apparatus that complies with the first embodiment of the present invention.

FIG. 4A is a plan view that schematically shows a three-dimensional printing apparatus that complies with a second embodiment of the present invention.

FIG. 4B is a side view that schematically shows a three-dimensional printing apparatus that complies with the second embodiment of the present invention.

FIGS. 5A to 5C are schematic views for describing a pulley mechanism unit of a three-dimensional printing apparatus that complies with the second embodiment of the present invention.

FIG. 6A is a plan view that schematically shows a three-dimensional printing apparatus that complies with a third embodiment of the present invention.

FIG. 6B is a side view that schematically shows a three-dimensional printing apparatus that complies with the third embodiment of the present invention.

FIG. 7A is a plan view that schematically shows a three-dimensional printing apparatus that complies with a fourth embodiment of the present invention.

FIG. 7B is a side view that schematically shows a three-dimensional printing apparatus that complies with the fourth embodiment of the present invention.

FIG. 7C is a front view that schematically shows a three-dimensional printing apparatus that complies with the fourth embodiment of the present invention.

FIG. 8 is a plan view that schematically shows a state in which a main unit of a three-dimensional printing apparatus that complies with a fourth embodiment of the present invention rotates.

FIG. 9 is a front view that schematically shows a three-dimensional printing apparatus that complies with a fifth embodiment of the present invention.

FIGS. 10A to 10E are front views that schematically show a movement step of a three-dimensional printing apparatus that complies with the fifth embodiment of the present invention.

FIG. 11 is a schematic plan view for describing a positional relationship between a three-dimensional printing apparatus that complies with the fifth embodiment of the present invention, a stage portion and a target printing object.

FIG. 12 is a schematic front view for describing an example of a printing unit of a three-dimensional printing apparatus that complies with the first to fifth embodiments of the present invention.

FIGS. 13A and 13B are schematic views for describing a printing method of a three-dimensional printing apparatus of the present invention.

FIG. 14 is a plan view that schematically shows a three-dimensional printing apparatus that complies with a different embodiment of the present invention.

FIGS. 15A to 15C are schematic plan views for describing the movement of a printing unit of a three-dimensional printing apparatus that complies with the different embodiment of the present invention.

### DETAILED DESCRIPTION OF THE INVENTION

Hereinafter embodiments of the three-dimensional printing apparatus of the present invention will be described with reference to the drawings.

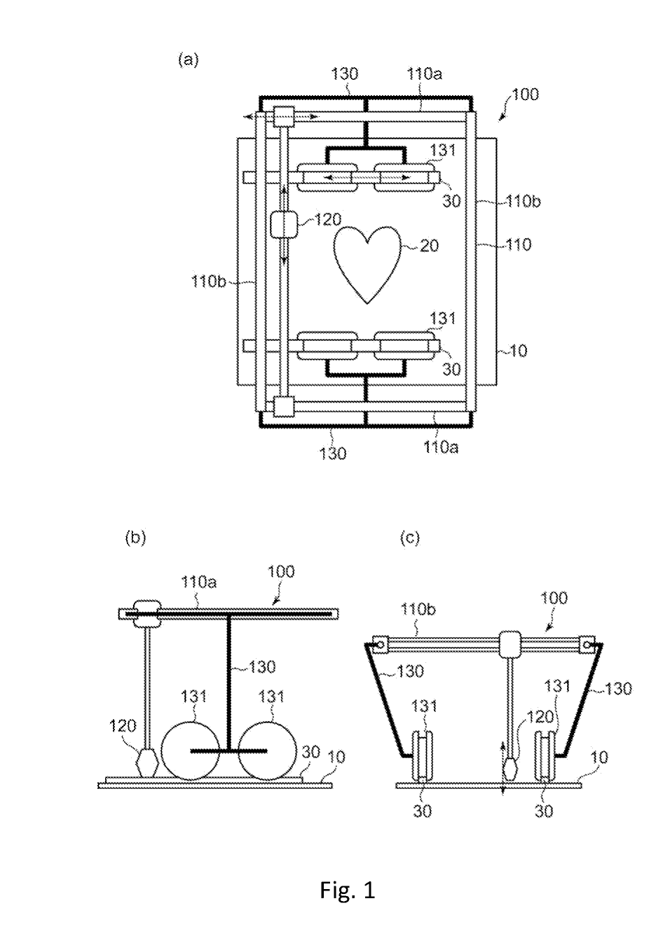

FIGS. 1A to 1C are views that schematically show a three-dimensional printing apparatus that complies with a first embodiment of the present invention. FIG. 1A shows a plan view, FIG. 1B shows a front view and FIG. 1C shows a side view.

As shown in FIGS. 1A to 1C, a three-dimensional printing apparatus 100 is provided with a main unit 110 and movement means 130, and the main unit 110 has a printing unit 120 and the movement means 130 are connected to the main unit 110. Additionally, in FIG. 1A, an example in which the main unit 110 is configured by a front bar 110a and a side bar 110b is shown, but in FIG. 1C, the front side bar 110b is omitted.

The printing unit 120 prints by laminating a target printing object 20 and a stage portion 30 at a printing locus 10 by placing a plurality of two-dimensional layers of materials of the target printing object 20 and a stage portion 30 in a specific direction. Examples of printing method include laser beam lithography that uses a liquid resin that is cured by being irradiated with ultraviolet rays; a powder method in which a raw material powder is spread out in layers and hardened by direct sintering with a high-power laser beam or the like, or by adding a binder using an ink jet method; fused deposition modeling in which a thermoplastic resin is melted and laminated at high temperature; an ink jet method that creates a shape by spraying and laminating a liquidized material, and the like, but in the present embodiment, an example of a case in which a target printing object 20 is produced using fused deposition modeling in particular is described.

The movement means 130 moves the three-dimensional printing apparatus 100 on a printing locus 10 with a stage portion 30 that is printed by the printing unit 120 as a stage.

Further, the printing unit 120 prints at least a part of a target printing object 20 at a position to which the three-dimensional printing apparatus 100 is moved.

That is, the three-dimensional printing apparatus 100 intermittently prints a target printing object 20 while producing a stage portion 30 and moving. More specifically, the three-dimensional printing apparatus 100 completes a target printing object 20 by repeating printing of a target printing object 20 and a stage portion 30 and moving. As a result of this, the three-dimensional printing apparatus 100 can increase the printable area to an area that exceeds the printable area at a position in which the three-dimensional printing apparatus 100 is placed in advance.

It is preferable that the stage portion 30 be a rail or a plurality of support pillars that are disposed like islands. Additionally, it is preferable that a minimum stage, on which the three-dimensional printing apparatus 100 is initially disposed, be provided in advance.

As shown in FIGS. 1A to 1C, in a case in which the abovementioned stage portion 30 is a rail, it is preferable that the movement means 130 have a support leg portion 131 that is capable of traveling on the rail. In FIGS. 1A to 1C, an example in which a target printing object 20 is printed between the abovementioned rails, but the embodiment is not limited thereto.

The abovementioned support leg portion 131 may be a wheel that rotates on the rail or a sliding body that slides on the rail. In the drawing, the abovementioned support leg portion 131 is configured by a plurality of wheels.

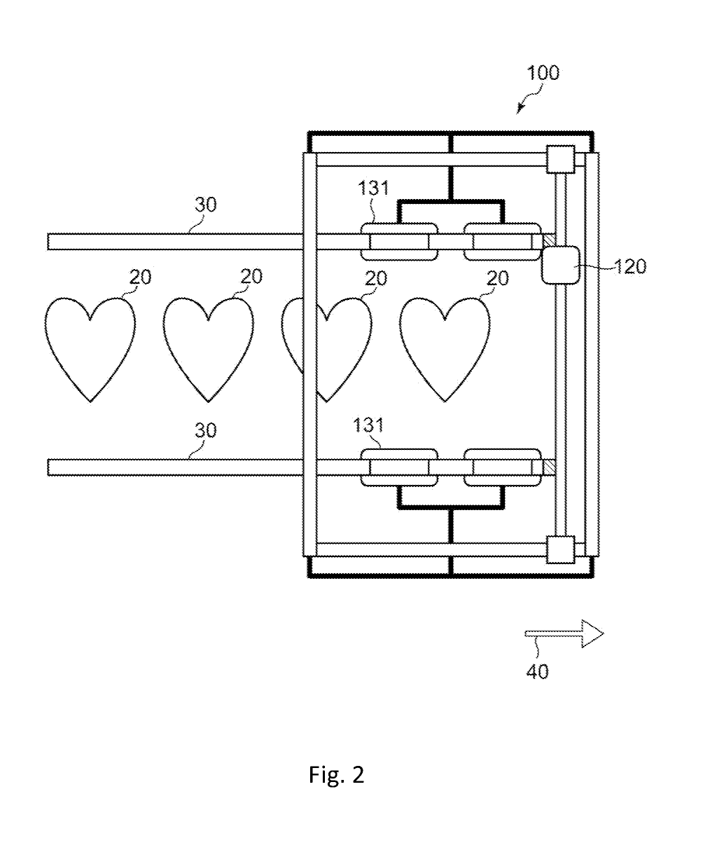

FIG. 2 is a plan view that schematically shows a three-dimensional printing apparatus 100 that complies with the first embodiment of the present invention, and an example in which the printing unit 120 expands the abovementioned rail in a direction that is parallel to a lamination surface and an extension direction of the rail is shown. In this example, since the printing unit 120 moves the three-dimensional printing apparatus 100 toward a direction that is shown by an arrow 40 in the drawing, a new rail is printed at the end of the rail.

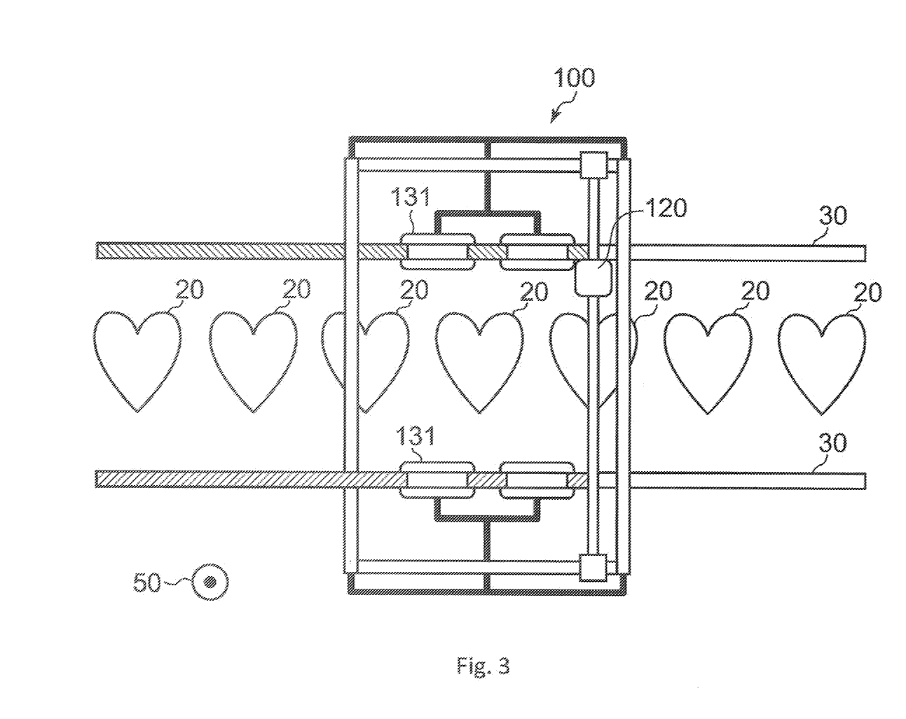

FIG. 3 is a plan view that schematically shows a three-dimensional printing apparatus 100 that complies with the first embodiment of the present invention, and an example in which the printing unit 120 expands the abovementioned rail in a direction that is perpendicular to the lamination surface is shown. In this example, since the printing unit 120 moves the three-dimensional printing apparatus 100 toward a proximal direction that is perpendicular to a paper surface, which is shown by a symbol 50 in the drawing, a new rail is printed above the rail.

In FIGS. 1 to 3, an example in which the abovementioned rail is a pair of rails that is printed linearly in parallel with one another is shown, but it is possible to print the rail in a curved manner.

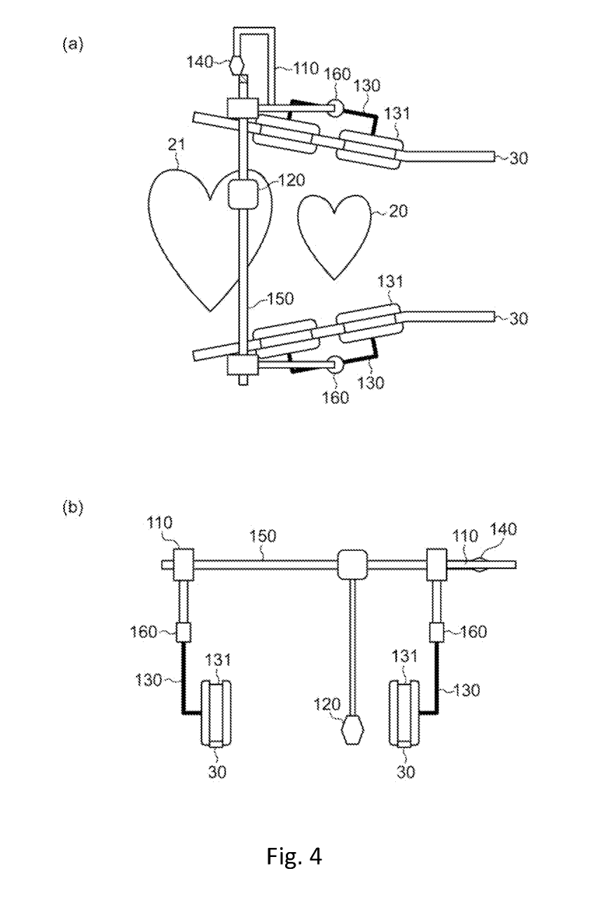

In addition, as shown in FIG. 4A, it is possible for the abovementioned rail to be printed so that a gap between the rails continuously changes. FIGS. 4A and 4B are views that schematically show a three-dimensional printing apparatus 100 that complies with a second embodiment of the present invention. FIG. 4A shows a plan view and FIG. 4B shows a side view.

In the example shown in FIGS. 4A and 4B, it is possible for the main unit 110 to have a printing area expansion unit 140 for expanding an area in which printing using the printing unit 120 is possible.

In a case in which the printing unit 120 is provided so as to be moveable with a rod portion 150 as an axis that is provided inside the main unit 110, the printing area expansion unit 140 may expand the rod portion 150.

More specifically, it is preferable that the printing unit be a printing unit that can print a new rod portion at the end of a rod portion 150. In addition, as a result of configuring a mechanism (for example, a latch mechanism or the like) in which the main unit 110 is moveable with respect to the rod portion 150, the moveable area of the printing unit 120 is expanded with movement of the movement means 130 on the stage portion 30, and it becomes possible to print a large target printing object 21. At this time, it is preferable that the main unit 110 and the movement means 130 be rotatably linked through a rotating body 160.

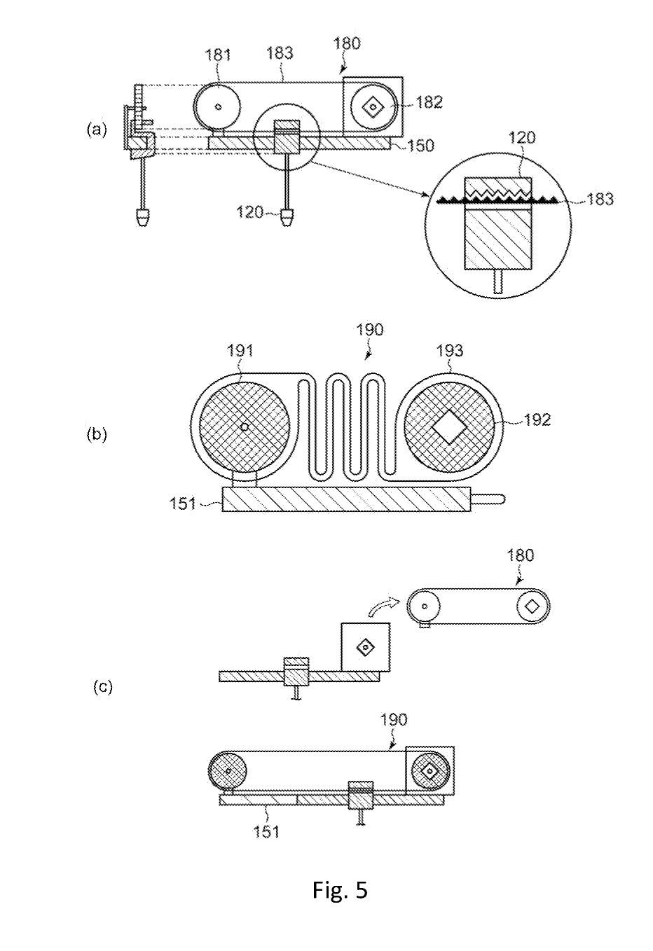

In addition, it is possible to expand the printable area by attaching a separately-formed new rod portion to the end of the rod portion 150. FIGS. 5A to 5C show an example in which the printing unit 120 is provided so as to be movable with a rod portion 150 as an axis that is provided inside the main unit 110 due to a pulley mechanism unit 180. More specifically, as shown in FIG. 5A, the pulley mechanism unit 180 is configured by two pulleys 181 and 182 and a belt 183, and the belt 183 and the printing unit 120 are formed so as to meshes with one another. Further, in a case in which the printing area of the printing unit 120 is expanded, as shown in FIG. 5B, a new pulley mechanism unit 190 that is longer than the belt and a rod portion 151 that is to be added are prepared separately, and as shown in FIG. 5C, the pulley mechanism unit 180 is removed using a robotic arm or the like, and the abovementioned new pulley mechanism unit 190 and the rod portion 151 that is to be added are attached. As a result of this, it is possible to expand the area in which printing using the printing unit 120 is possible. Additionally, it is possible for the new pulley mechanism unit 190 and the like to be formed separately using the three-dimensional printing apparatus of the present invention.

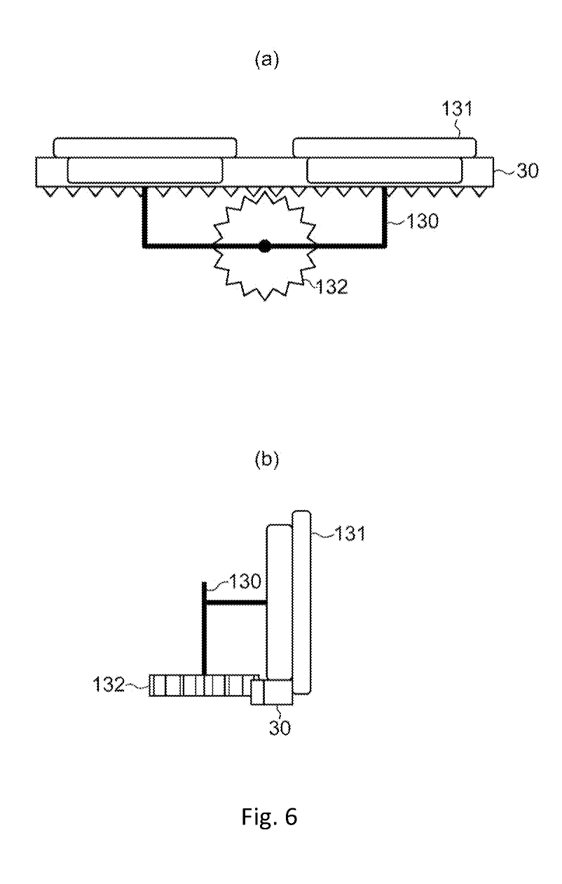

In addition, as shown in FIGS. 6A and 6B, the movement means 130 may have a pinion portion 132 that is a gear, and the abovementioned rail may be a rack rail that meshes with the pinion portion 132. FIGS. 6A and 6B are views that schematically show a three-dimensional printing apparatus 100 that complies with a third embodiment of the present invention. FIG. 6A shows a plan view and FIG. 6B shows a side view. The abovementioned rack rail may be produced by for example, carrying out a machining process (described later) on a printed stage portion 30.

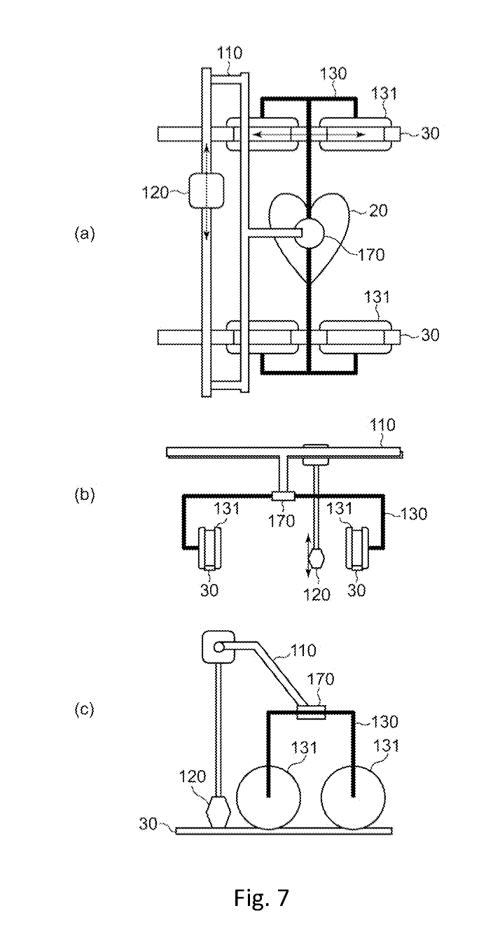

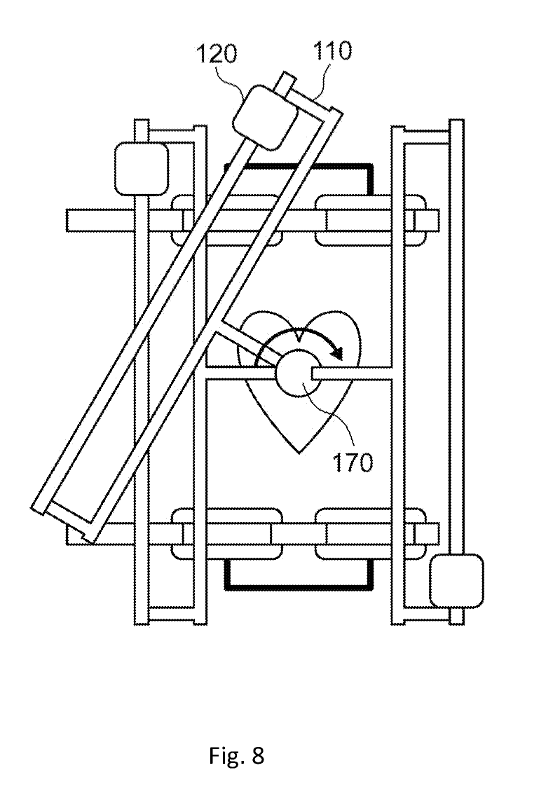

FIGS. 7A to 7C and 8 are views that schematically show a three-dimensional printing apparatus 100 that complies with a fourth embodiment of the present invention. FIG. 7a shows a plan view, FIG. 7B shows a side view, FIG. 7C shows a front view and FIG. 8 shows a state in which the main unit 110 shown in FIGS. 7A to 7C rotates.

In the examples shown in FIGS. 7A to 7C and 8, it is preferable that the main unit 110 and the movement means 130 be rotatably linked through a rotating body 170. Further, as shown in FIG. 8, it is possible for the main unit 110 to change the printable area of the printing unit 120 by rotating with the abovementioned rotating body 170 as the center thereof. This is effective in a case of for example, changing the expansion direction of the stage portion 30 or the like. According to this configuration, it is possible to configure the main unit 110 to be more compact in comparison with a three-dimensional printing apparatus 100 that complies with the first embodiment.

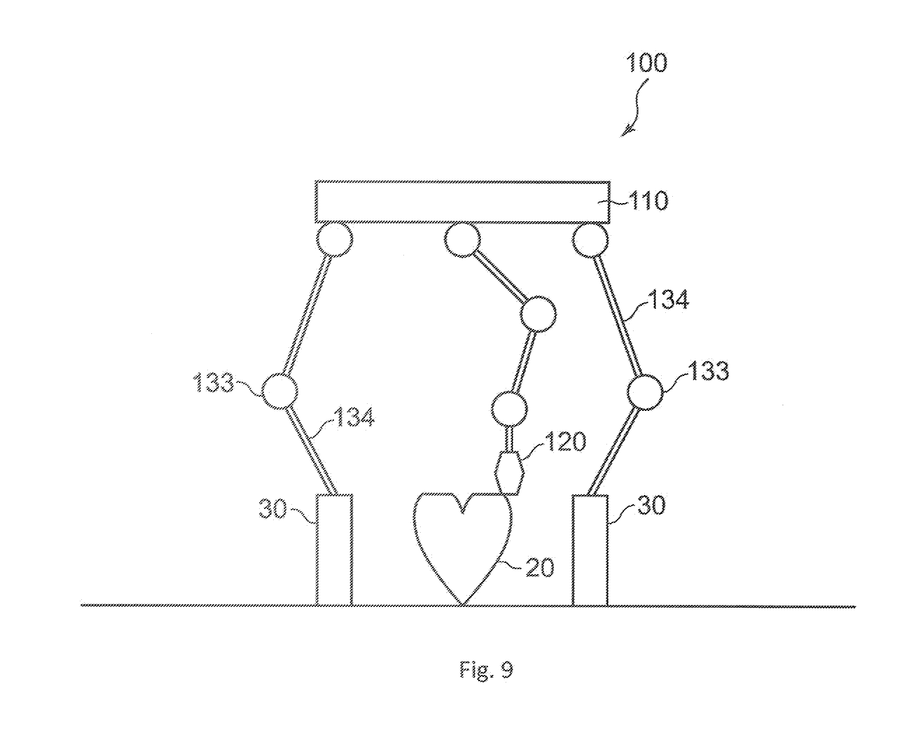

FIG. 9 is a view that schematically shows a three-dimensional printing apparatus 100 that complies with a fifth embodiment of the present invention, and an example in which the abovementioned stage portion 30 is a plurality of support pillars that are disposed like islands is shown. At this time, it is preferable that the movement means 130 have a support leg portion 134 that is capable of moving on the abovementioned support pillars. In FIG. 9, an example in which the abovementioned support leg portion 134 has one or more joint portions 133 is shown, but for example, it is also possible to configure so that the support leg portion 134 can move on the abovementioned support pillars as a result of having a combination of an actuator that expands and contracts and a sliding mechanism. In addition, in FIG. 9, an example in which a target printing object 20 is printed between the abovementioned support pillars is shown but the embodiment is not limited thereto.

Additionally, the number of support leg portions 134 is not particularly limited provided it is a number that is capable of supporting the main unit 110, but is preferably four or more. If there are fewer than four support leg portions 134, as will be described later, there is a concern that the main unit 110 will collapse in a case in which one support leg portion is lifted. Furthermore, since it is possible to lift the support leg portions without movement of the center of gravity, a person skilled in the art could have easily predicted that there be five or more support leg portions, and having six support leg portions is more preferable in order to facilitate control.

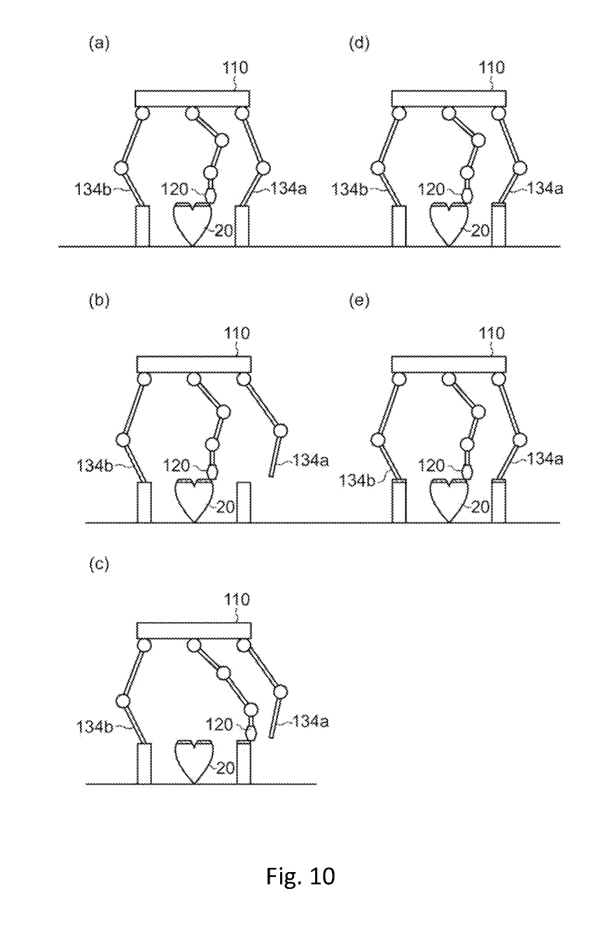

In addition, the printing unit 120 can expand the abovementioned support pillars in a direction that is perpendicular to the lamination surface. FIGS. 10A to 10E are views for describing a movement step of a three-dimensional printing apparatus 100 that complies with the fifth embodiment of the present invention. Firstly, as shown in FIG. 10A, the printing unit 120 laminates a target printing object 20. Next, as shown in FIG. 10B, a support leg portion 134a is disconnected from the support pillars, and as shown in FIG. 10C, the support pillars therebelow are laminated. Next, as shown in FIG. 10D, the support leg portion 134a is returned to the support pillars, and a different support leg portion 134b is disconnected from the support pillars, and as shown in FIG. 10E, the support pillars therebelow are laminated.

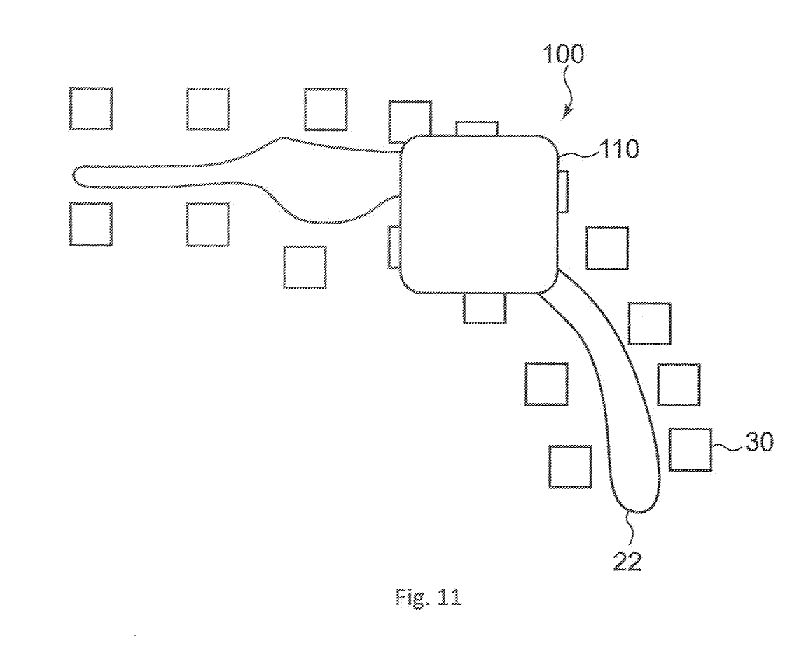

Furthermore, the printing unit 120 can increase the abovementioned support pillars in a direction that is parallel to a lamination surface. FIG. 11 shows an example in which a large target printing object 22 is produced by increasing the support pillars.

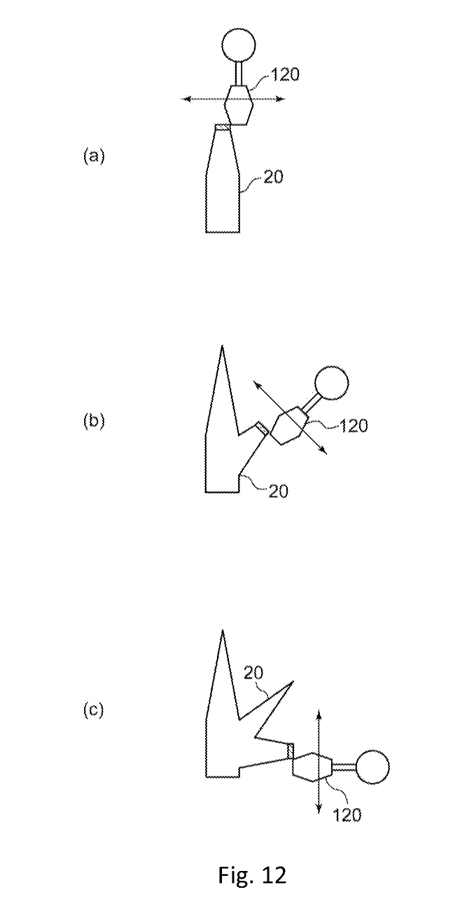

In addition, as shown in FIGS. 9 and 10, it is preferable that the printing unit 120 be connected to the main unit 110 by an arm that has one or more joint portions. Further, as shown in FIGS. 12A to 12C, it is possible to print a target printing object 20 with a variety of angles by configuring such that the angle of the lamination surface of the printing unit 120 can be variable.

In addition, although not shown in the drawings, it is preferable that the main unit 110 have a machining unit for carrying out a machining process on a target printing object 20 or a stage portion 30 printed by the printing unit 120.

The abovementioned machining unit can carry out a smoothing process, a positioning part formation process or a removal process on a target printing object 20 or a stage portion 30 printed by the printing unit. A smoothing process refers to, for example, a process that smoothes down the upper surface or side surface of a target printing object 20 or a stage portion 30 by moving a tooth that rotates. A positioning part formation process refers to, for example, a process that forms a concave part, a convex part or the like in a stage portion 30 for the registration of a position at which the movement means 130 stops. A removal process refers to, for example, a process that removes an obsolete stage portion.

In addition, although not shown in the drawings, it is preferable that a three-dimensional printing apparatus that complies with a different embodiment of the present invention be provided with a position recognition unit for recognizing the position of the three-dimensional printing apparatus on the printing locus.

It is preferable that the abovementioned position recognition unit have an image capture unit that captures an image of at least one of a part of the three-dimensional printing apparatus, the printing locus, a target printing object or a stage portion, and it is possible to recognize the position of the three-dimensional printing apparatus on the basis of an image captured by the image capture unit.

In addition, it is preferable that the printing unit print a reference portion that forms a reference for the position recognition unit to recognize the position of the three-dimensional printing apparatus. Examples of the shape of a reference portion include a cross shape, a square shape or the like.

At this time, it is preferable that the position recognition unit have an image capture unit that captures an image of at least one of a part of the three-dimensional printing apparatus, the printing locus, a target printing object, a stage portion or a reference portion, and it is possible to recognize the position of the three-dimensional printing apparatus on the basis of an image captured by the image capture unit.

In addition, it is preferable that a three-dimensional printing apparatus of the present invention be provided with a function that adjusts the position of the three-dimensional printing apparatus on the basis of a position recognized by the abovementioned position recognition unit.

Alternatively, it is preferable that a three-dimensional printing apparatus of the present invention be provided with a function that modifies print data that is to be printed at the position of the three-dimensional printing apparatus on the basis of a position recognized by the abovementioned position recognition unit. According to this function, with respect to the control of position, it is possible to further simplify the configuration of a three-dimensional printing apparatus of the present invention because a high degree of accuracy is not required.

In addition, the abovementioned printing locus can, for example, be configured to be a platform or the like that is disposed on a table or the like, but the printing locus is not limited thereto, and a table, shelf, wall, ceiling or the like can be configured as a printing locus, and a stage portion and target printing object can be printed directly onto a wall or the like. In such a case, it is possible to expand a top panel of a table or a shelf, form a rack on a wall, increase the size of a doorknob or the like. Furthermore, it is possible to perform an initial 3D scan of a printing locus, and configure so as to control a printing position or the like of a target printing object. At this time, it is not necessary for the stage portion and the printing locus to be the same surface, and for example, it is possible for the stage portion to be on a table and configure so as to print on a wall.

In addition, in a case in which a stage portion is produced on a wall or a ceiling, it is possible to configure such that the three-dimensional printing apparatus does not fall by providing an angular part in the support leg portion and configuring so that this part penetrates into the stage portion. Furthermore, it is possible to configure such that the three-dimensional printing apparatus does not fall by printing a stage portion using a magnetic material, disposing a permanent magnet or an electromagnet in the support leg portion and using a magnetic force that is generated therebetween; or using an intermolecular force or an adhesive force that is generated between the stage portion and the support leg portion.

In addition, it is preferable that the stopping position in each layer of the three-dimensional printing apparatus of the present invention be set so as to differ for each layer. This is due to the fact that there are cases in which seam regions stand out, the strength of the target printing object is reduced or the like when the stopping position of the three-dimensional printing apparatus is continuously set as the same position in each layer of a target printing object when printing a target printing object.

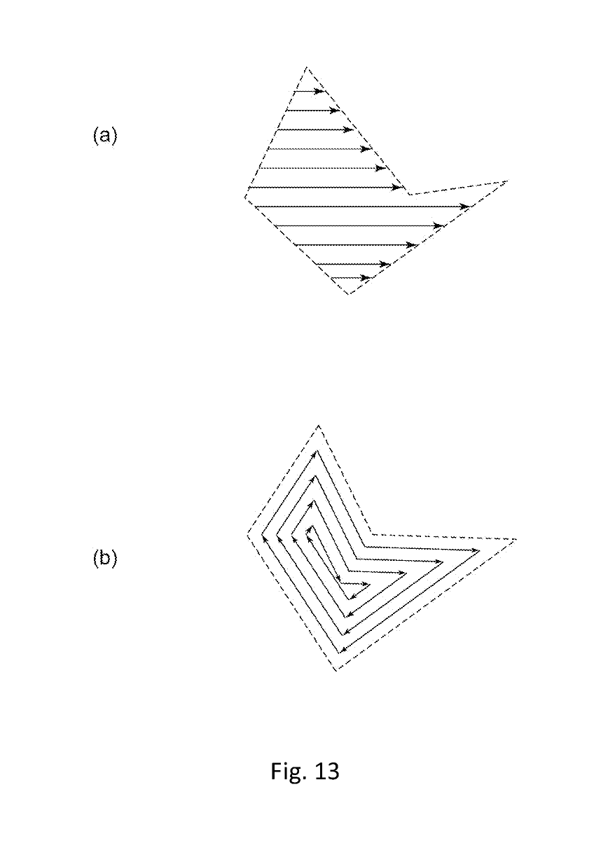

In addition, it is possible to configure a printing shape to be a raster shape or a vector shape but, a vector shape is preferable since it is possible to form smoother side surfaces. FIGS. 13A and 13B are schematic views that show respective states of printing using a raster shape and a vector shape. As shown in FIG. 13A, since printing using a raster shape forms a target printing object by printing parallel lines that are shown with an arrow in the drawing, there is a tendency for the side surfaces of a completed target printing object to be coarse. On the other hand, as shown in FIG. 13B, since printing using a vector shape performs printing along an outer contour of a target printing object as shown by an arrow in the drawing, it is possible to form the side surfaces of a target printing object smoothly.

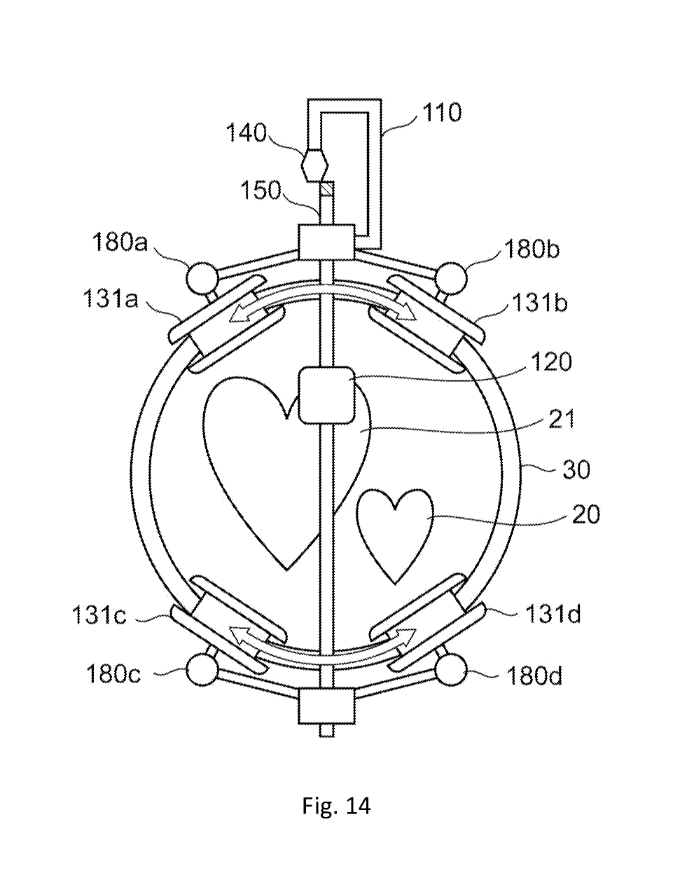

In addition, it is possible to configure the stage portion 30 described above as a circuit rail as shown in FIG. 14. This rail can be laminated so as to gradually change the size and shape in the height direction to match the external shape of a target printing object 20 or 21. More specifically, it is possible to laminate so that the rail forms a pot shape or the like in a frontal view or the like. Additionally, a case in which the shape of the circuit is circular is shown in the drawing, but is not limited to this provided the shape is a closed curve.

Furthermore, it is preferable that support leg portions 131a to 131d, which are wheels, are respectively configured so as to be rotatable by rotating bodies 180a to 180d. As a result of this, it is possible to prevent derailment of the support leg portions 131a to 131d from the rail.

Additionally, it is possible to provide the printing unit 120 so as to be moveable with a rod portion 150 as an axis that is provided inside the main unit 110, and for the main unit 110 to have a printing area expansion unit 140 for expanding an area in which printing using the printing unit 120 is possible in the same manner as the example of the second embodiment that is described above. In such a case, the printing area expansion unit 140 is configured to expand the rod portion 150.

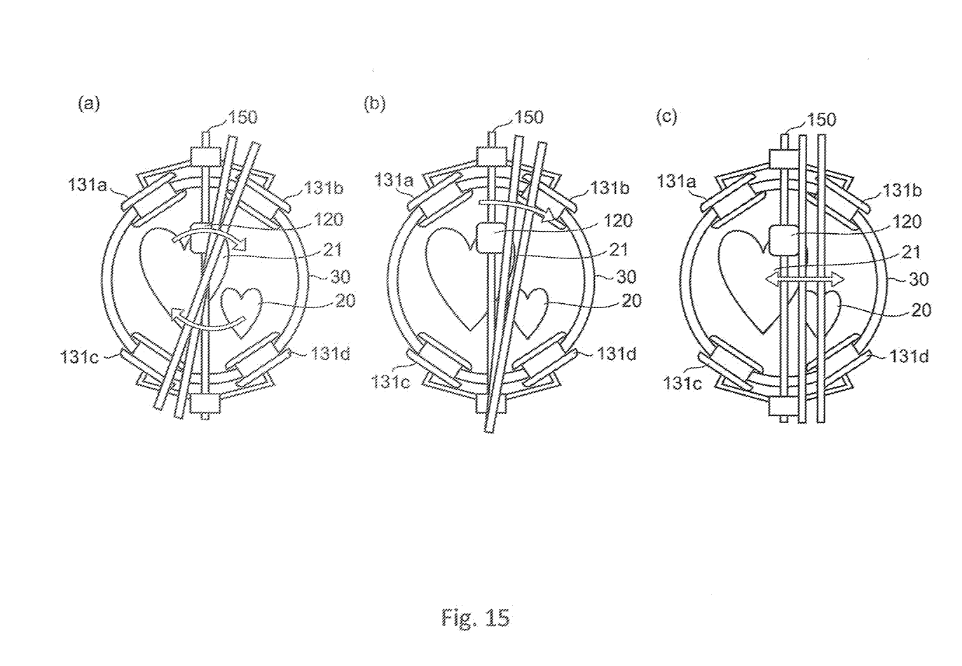

FIGS. 15A to 15C are schematic views for describing the movement of the rod portion 150. FIG. 15A is an example in which the support leg portions 131a and 131b, and the support leg portions 131c and 131d are moved in the same direction (clockwise in the drawing). At this time, the rod portion 150 rotates in a direction (clockwise) shown by an arrow in the drawing with the center of the circuit as the center of rotation thereof. FIG. 15B is an example in which only the support leg portions 131a and 131b are moved clockwise. At this time, the rod portion 150 fixes the side of the support leg portions 131c and 131d and the side of the support leg portions 131a and 131b rotates. FIG. 15C is an example in which the support leg portions 131a and 131b, and the support leg portions 131c and 131d are moved in mutually opposite directions (the support leg portions 131a and 131b clockwise and the support leg portions 131c and 131d anticlockwise). At this time, the rod portion 150 moves in a parallel manner to the right side in the drawing. As a result of adopting such a configuration, it is possible to change a printing direction and a printing pattern of the printing unit 120 to be more flexible.

Next, an embodiment of a three-dimensional printing system of the present invention will be described.

A three-dimensional printing system of the present invention is provided with two or more of the three-dimensional printing apparatuses of the present invention that are described above. Further, the three-dimensional printing system of the present invention prints the same target printing object 20 by causing the three-dimensional printing apparatuses to cooperate. In this manner, it is possible to complete a target printing object in a short period of time in a case in which for example, a large target printing object is printed or the like by concurrent processes using a plurality of three-dimensional printing apparatuses. The details of the three-dimensional printing apparatuses are the same as those described above.

Next, an embodiment of a three-dimensional printing method of the present invention will be described.

A three-dimensional printing method of the present invention, in which three-dimensional printing is performed using a three-dimensional printing apparatus that is provided with a main unit and movement means that are connected to the main unit 110, is provided with a stage portion printing step, a movement step, and a target printing object printing step.

In the abovementioned stage portion printing step, a stage portion is printed by lamination thereof. It is possible for this printing to be performed by the printing unit described above for example. The details of the printing unit are the same as those described above.

The abovementioned movement step moves the three-dimensional printing apparatus over a printing locus with a stage portion that is printed in the stage portion printing step as a stage. It is possible for this movement to be performed by the movement means described above for example. The details of the movement means are the same as those described above.

The abovementioned target printing object printing step prints by laminating at least a part of a target printing object at a position to which the three-dimensional printing apparatus is moved. It is possible for this printing to be performed by the printing unit described above for example. The details of the printing unit are the same as those described above.

The features described above show examples of representative embodiments and the present invention is not limited by the embodiments.

What is claimed is:

1. A three-dimensional printing apparatus comprising:
a main unit; and
movement means that is connected to the main unit,
wherein the main unit has a printing unit for printing by laminating a target printing object and a stage portion at a printing locus,
the movement means moves the three-dimensional printing apparatus over the printing locus with a stage portion that is printed by the printing unit as a stage, and
the printing unit prints at least a part of a target printing object at a position to which the three-dimensional printing apparatus is moved.

2. The three-dimensional printing apparatus according to claim 1,
wherein the stage portion is a rail, and
the movement means has a support leg portion that is capable of traveling on the rail.

3. The three-dimensional printing apparatus according to claim 2,
wherein the support leg portion is a wheel that rotates on the rail or a sliding body that slides on the rail.

4. The three-dimensional printing apparatus according to claim 2,
wherein the printing unit expands the rail in a direction that is parallel to a lamination surface and an extension direction of the rail.

5. The three-dimensional printing apparatus according to claim 2,
wherein the printing unit expands the rail in a direction that is perpendicular to the lamination surface.

6. The three-dimensional printing apparatus according to claim 2,
wherein the rail is a pair of rails, and printing is performed so that a gap between the rails continuously changes.

7. The three-dimensional printing apparatus according to claim 2,
wherein the movement means has a pinion portion that is a gear, and
the rail is a rack rail that meshes with the pinion portion.

8. The three-dimensional printing apparatus according to claim 1,
wherein the stage portion is a plurality of support pillars that are disposed like islands, and
the movement means has a support leg portion that is capable of moving on the support pillars.

9. The three-dimensional printing apparatus according to claim 8,
wherein the printing unit increases the support pillars in a direction that is parallel to a lamination surface.

10. The three-dimensional printing apparatus according to claim 8,
wherein the printing unit expands the support pillars in a direction that is perpendicular to a lamination surface.

11. The three-dimensional printing apparatus according to claim 1,
wherein the main unit has a printing area expansion unit for expanding an area in which printing using the printing unit is possible.

12. The three-dimensional printing apparatus according to claim 11,
wherein the printing unit is provided so as to be moveable with a rod portion as an axis that is provided inside the main unit, and
the printing area expansion unit expands the rod portion.

13. The three-dimensional printing apparatus according to claim 1,
wherein the printing unit is connected to the main unit by an arm that has one or more joint portions, and
an angle of the lamination surface of the printing unit is variable.

14. The three-dimensional printing apparatus according to claim 1,
wherein the main unit has a machining unit for carrying out a machining process on a target printing object or a stage portion which is printed by the printing unit.

15. The three-dimensional printing apparatus according to claim 1,
wherein the three-dimensional printing apparatus is provided with a position recognition unit for recognizing the position of the three-dimensional printing apparatus on the printing locus.

16. The three-dimensional printing apparatus according to claim 15,
wherein the position recognition unit has an image capture unit that captures an image of at least one of a part of the three-dimensional printing apparatus, the printing locus, a target printing object and a stage portion, and
recognizes the position of the three-dimensional printing apparatus on the basis of an image captured by the image capture unit.

17. The three-dimensional printing apparatus according to claim 15,
wherein the printing unit prints a reference portion that forms a reference for the position recognition unit to recognize the position of the three-dimensional printing apparatus.

18. The three-dimensional printing apparatus according to claim 17,
wherein the position recognition unit has an image capture unit that captures an image of at least one of a part of the three-dimensional printing apparatus, the printing locus, a target printing object, a stage portion and a reference portion, and
recognizes the position of the three-dimensional printing apparatus on the basis of an image captured by the image capture unit.

19. A three-dimensional printing system comprising: a first three-dimensional printing apparatus which is provided with a main unit and movement means that is connected to the main unit, and in which the main unit has a printing unit for printing by laminating a target printing object and a stage portion at a printing locus, the movement means moves the three-dimensional printing apparatus over the printing locus with a stage portion that is printed by the printing unit as a stage, and the printing unit prints at least a part of a target printing object at a position to which the three-dimensional printing apparatus is moved; and
a second three-dimensional printing apparatus that is provided with a main unit and movement means that is connected to the main unit, in which the main unit has a printing unit for printing by laminating a target printing object and a stage portion at a printing locus, the movement means moves the three-dimensional printing apparatus over the printing locus with a stage portion that is printed by the printing unit as a stage, and the printing unit prints at least a part of a target printing object at a position to which the three-dimensional printing apparatus is moved,
wherein the first three-dimensional printing apparatus and the second three-dimensional printing apparatus cooperate in the printing of the same target printing object.

20. A method for performing three-dimensional printing using a three-dimensional printing apparatus that is provided with a main unit and movement means that is connected to the main unit, the method comprising:
a stage portion printing step of printing by laminating a stage portion;
a movement step of moving the three-dimensional printing apparatus over a printing locus with a stage portion that is printed in the stage portion printing step as a stage; and
a target printing object printing step of printing by laminating at least a part of a target printing object at a position to which the three-dimensional printing apparatus is moved.
